(19) United States
(12) Patent Application Publication
(10) Pub. No.: US 2020/0359094 A1
(43) Pub. Date: Nov. 12, 2020

(54) SCREEN PARAMETER CONFIGURATION SYSTEM

(71) Applicant: Amlogic (Shanghai) Co., Ltd., Shanghai (CN)

(72) Inventor: Shoufu Zhao, Shanghai (CN)

(21) Appl. No.: 16/342,073

(22) PCT Filed: Oct. 31, 2018
(86) PCT No.: PCT/CN2018/113148

§ 371 Date: Apr. 15, 2019

(30) Foreign Application Priority Data
Jan. 18, 2018 (CN) 201810050897.7

(51) Int. Cl. H04N 21/45; H04N 21/262; H04N 21/443; H04N 21/458; H04N 21/81

(52) U.S. Cl. CPC H04N 21/4516; H04N 21/26291; H04N 21/8173; H04N 21/4586; H04N 21/443

(57) ABSTRACT

The invention discloses a screen parameter configuration system, applied to an intelligent terminal provided with a screen and an operation system, the screen parameter configuration system is built based on the operation system, wherein an LCD driver of the operation system does not comprise any specific screen parameter, screen configuration information is stored in one data partition, and a user can search the screen parameter information according to a screen ID; and the searched screen parameter information is converted into a binary format so as to be read and used by the LCD driver. The invention can be applied in TVs of various models, and the compiling work of a system upgrade package is reduced; the screen parameter configuration information can be added and modified to avoid the complete upgrade of the operation system, thereby reducing the workload of importing the software and improving the production efficiency.

### BACKGROUND OF THE INVENTION

### 1. Field of the Invention

The invention relates to the technical field of smart televisions, and more particularly, to a screen parameter configuration system applied to an intelligent terminal provided with a screen.

### 2. Description of the Related Art

Smart TV solution providers or OEMs may have established business relations with many customers. According to customers' requirements, screens for each customer's product may be different. In this case, for screens of various models, corresponding screen parameters shall be configured in the operation system of the smart TV, such that the operation system can drive the screen to work.

At present, during the research & development process and the production process of the smart TV hosts, a method for supporting a screen by using a system upgrade package is adopted. In this method, corresponding system upgrade needs to be compiled depending on the screens in different models, hence, during the research & development process and the production process of the smart TV hosts, compiling of different system upgrade is required in response to the fact that different customers use screens in different models. For a TV host available for assembling of a TV, if a new screen needs to be reconfigured, the R&D department needs to compile a new system upgrade package and re-burn the new system upgrade package to the TV host, and to compile a corresponding test program and burn the corresponding test program to a test device for the screen of a new model. It should be noted that the size of one system upgrade package ranges from a few hundred MB to several GB. Compiling and burning the entire upgrade package on the production line is a cumbersome and time-consuming task. As a result, workload of the R&D department, the test department and the production department is increased, communication and coordination among different departments many increased, therefore, the R&D efficiency, testing efficiency and production efficiency is lowered.

### SUMMARY OF THE INVENTION

With respect to the foregoing problems in the prior art, the present invention provides a screen parameter configuration system, which intends to solve the problem that heavy workload and low production efficiency is incurred during the research & development and the production process of the smart TV since different system upgrade packages need to be compiled and burned for different users. The present invention adopts the following technical solution.

A screen parameter configuration system applied to an intelligent terminal, wherein the intelligent terminal is provided with a screen and an operation system, the screen parameter configuration system is built based on the operation system, and the screen parameter configuration system comprises:

a first storage module configured to store a screen configuration file in a default first format, the screen configuration file comprises a plurality of screen configuration information, each of the plurality of screen configuration information comprises a screen ID and screen parameter information corresponding to the screen ID;

a selection module, connected to the first storage module, configured to provide a screen ID selection menu comprising a plurality of screen IDs for a user to select from, and configured to receive one of the plurality of screen IDs selected by the user;

a parse module, connected to the selection module and the first storage module, configured to read the screen ID selected by the user, configured to query the corresponding screen parameter information in the first storage module according to the screen ID, and configured to output a query result according to the corresponding screen parameter information; and

a conversion module, connected to the parse module, configured to convert the screen parameter information in the query result from the first format to a default second format, and configured to store the screen parameter information in the corresponding second format in a second storage module such that the screen parameter information is allowed to be read and utilized by an LCD driver in the operation system.

Preferably, in the above-mentioned screen parameter configuration system, the first format is a text format; and the second format is a binary format.

Preferably, in the above-mentioned screen parameter configuration system, the operation system has a PowerShadow Master;

the screen parameter configuration system further comprises:

a debugging module, connected to the selection module, configured to have modifiable parameter items in the screen parameter information displayed on the screen according to the screen ID selected by the user, for the user to modify the corresponding parameter items, and configured to additionally save the parameter items modified by the user and the corresponding screen ID in the PowerShadow Master as screen parameter debugging information.

Preferably, in the above-mentioned screen parameter configuration system, the parse module comprises:

a first query unit, configured to query the screen parameter debugging information in the PowerShadow Master according to the screen ID selected by the user, and configured to output a first query result according to the parameter items when the corresponding screen parameter debugging information is obtained, and configured to output a second query result when the corresponding screen parameter debugging information is not obtained; and

a second query unit, connected to the first query unit, configured to query the first storage module according to the screen ID selected by the user so as to obtain corresponding screen parameter information upon receiving the second query result, and configured to output a third query result according to the screen parameter information, wherein the query result is the first query result or the third query result.

Preferably, the above-mentioned screen parameter configuration system further comprises:

an extraction module, connected to the selection module, and configured to extract the corresponding screen parameter debugging information from the PowerShadow Master according to the screen ID selected by the user;

a copy module, connected to the selection module and the first storage module, configured to search the corresponding screen configuration information from the first storage module according to the screen ID selected by the user and to copy the screen configuration information searched out by the user; and

a modifying module, connected to the copy module and the extraction module, configured to obtain the copied screen configuration information and to modify the copied screen configuration information according to the screen parameter debugging information, and configured to configure the modified screen configuration information with a new screen ID to obtain new screen configuration information.

Preferably, the above-mentioned screen parameter configuration system further comprises:

an edit module, configured to edit the screen configuration information for the user.

Preferably, the above-mentioned screen parameter configuration system further comprises:

an update module, connected to the first storage module and the modifying module or the edit module, and configured to update the new screen configuration information in the screen configuration file.

Preferably, the above-mentioned screen parameter configuration system further comprises:

a generation module, connected to the first storage module, and configured to generate an incremental upgrade package according to the new screen configuration information; and

an export module, connected to the generation module, and configured to export the incremental upgrade package operated by the user.

Preferably, the above-mentioned screen parameter configuration system further comprises:

an upgrade module, configured to receive the incremental upgrade package, and configured to upgrade the operation system by using the incremental upgrade package.

The technical solution disclosed by the invention has the advantages that various pieces of screen parameter configuration information are configured in the operation system of a TV host for application in TVs of various models, and the compiling work of a system upgrade package is reduced; the screen parameter configuration information can be added and modified to avoid the complete upgrade of the operation system; the workload of importing the software in the production and research and development process is effectively reduced, and the production efficiency is improved.

### BRIEF DESCRIPTION OF THE DRAWINGS

The accompanying drawings, together with the specification, illustrate exemplary embodiments of the present disclosure, and, together with the description, serve to explain the principles of the present invention.

FIGS. 1 and 2 are block diagrams showing a structure of a screen parameter configuration system in a preferred embodiment according to the present invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, the term “plurality” means a number greater than one.

Hereinafter, certain exemplary embodiments according to the present disclosure will be described with reference to the accompanying drawings.

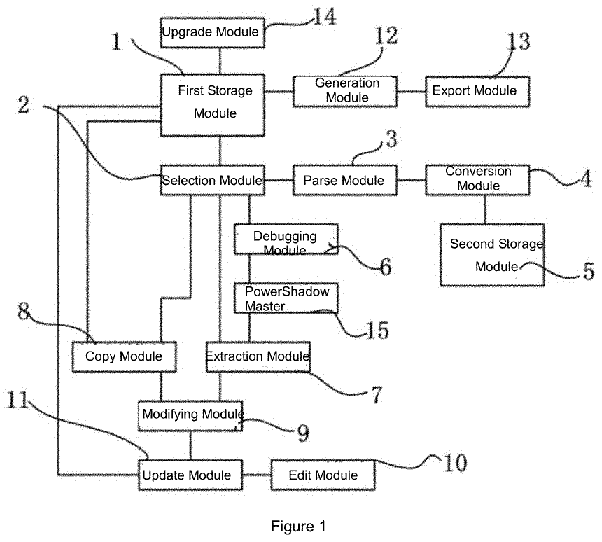

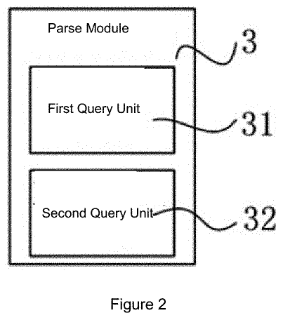

In a preferred embodiment, as shown in FIGS. 1 and 2, a screen parameter configuration system applied to an intelligent terminal. In this embodiment, the intelligent terminal is a smart TV provided with a screen and an operation system, the screen parameter configuration system is built based on the operation system, and the screen parameter configuration system comprises:

a first storage module 1 configured to store a screen configuration file in a default first format, wherein the screen configuration file comprises a plurality of screen configuration information, each of the plurality of screen configuration information comprises a screen ID and screen parameter information corresponding to the screen ID;

a selection module 2, connected to the first storage module 1, configured to provide a screen ID selection menu comprising a plurality of screen IDs for a user to select from, and configured to receive one of the plurality of screen IDs selected by the user;

a parse module 3, connected to the selection module 2 and the first storage module 1, configured to read the screen ID selected by the user, configured to query the corresponding screen parameter information in the first storage module 1 according to the screen ID, and configured to output a query result according to the corresponding screen parameter information; and

a conversion module 4, connected to the parse module 3, configured to convert the screen parameter information in the query result from the first format to a default second format, and configured to store the screen parameter information in the corresponding second format in a second storage module 5 such that the screen parameter information is allowed to be read and utilized by an LCD driver in the operation system.

In a preferred embodiment of the present invention, the first format is a text format; and the second format is a binary format.

In this embodiment, during the R&D process and production process of the smart TV host, a system upgrade package of the operation system having the above-mentioned screen parameter configuration system is compiled and burned into the smart TV host. The first storage module 1 is a data partition of the operation system, and a screen configuration file in a text format is stored in the data partition, then the user can select a corresponding screen parameter according to the model of the smart TV. Specifically, when a user sets the screen parameters, the selection module 2 provides a factory menu and the factory menu is displayed to the user through the screen of the smart TV. The factory menu reads all the screen IDs in the first storage module 1 and all the screen IDs are displayed on the screen for the user to select from. The selection module 2 is further configured to receive the screen ID selected by the user, the parse module 3 is configured to search the corresponding screen parameter information in the screen configuration file according to the screen ID selected by the user, and the searched screen parameter information is converted from a text format into a binary format by the conversion module 4 and is stored in the second storage module 5 so as to be read and utilized by the LCD driver in the operation system, wherein the second storage module 5 is a flash memory on the smart TV host.

In the above-mentioned technical solution, with respect to the screen driver of the smart TV, the LCD driver in the operation system is not provided with corresponding screen parameters, but stores various pieces of screen parameter information in a text format in a data partition of the operation system, and codes and data of the LCD driver are separated. For smart TVs in different models, expected screen parameters may be obtained simply by selecting the corresponding screen ID. Therefore, during the R&D process and production process of the smart TV, it is not necessary to compile different system upgrade packages of various operation systems for screens in different models, so as to reduce the preparation work of the system upgrade package before the production. In addition, there is no need to re-burn new system upgrade packages when the screen parameters need to be modified for the finished smart TV, such that the workload of burning software during the production process is reduced, thus, the R&D efficiency and the production efficiency is significantly improved.

In a preferred embodiment of the present invention, the operation system has a PowerShadow Master 15.

The screen parameter configuration system further comprises:

a debugging module 6, connected to the selection module 2, configured to have modifiable parameter items in the screen parameter information displayed on the screen according to the screen ID selected by the user, for the user to modify the corresponding parameter items, and configured to additionally save the parameter items modified by the user and the corresponding screen ID in the PowerShadow Master 15 as screen parameter debugging information.

In a preferred embodiment of the present invention, as shown in FIG. 2, the parse module 3 comprises:

a first query unit 31, configured to query the screen parameter debugging information in the PowerShadow Master 15 according to the screen ID selected by the user, and configured to output a first query result according to the parameter items when the corresponding screen parameter debugging information is obtained, and configured to output a second query result when the corresponding screen parameter debugging information is not obtained; and

a second query unit 32, connected to the first query unit 31, configured to query the first storage module 1 according to the screen ID selected by the user so as to obtain corresponding screen parameter information upon receiving the second query result, and configured to output a third query result according to the screen parameter information, wherein the query result is the first query result or the third query result.

In this embodiment, the screen parameter configuration system has a debugging module 6. When the screen configuration file stored in the screen parameter configuration system does not meet the needs of the user, the user is provided with the corresponding screen parameters to be modified. The debugging module 6 displays the modifiable parameter items in the corresponding screen parameter information to the user according to the screen ID selected by the user, and the user can modify the corresponding parameter items as desired, and the modified parameter items and the corresponding screen ID are additionally stored in the PowerShadow Master 15 as the screen parameter debugging information, and the existing parameter configuration files in the screen parameter configuration system are not modified. The user selects the corresponding screen ID through the selection module 2, and the first query module 31 of the parse module 3 reads the parameter items modified by the user from the PowerShadow Master 15 according to the corresponding screen ID, and the operation system drives the screen according to the read parameter items, such that the user can view the display effect of the screen when using the current screen parameters, and the user can debug again to get the required screen parameter information.

In the above-mentioned technical solution, the parameter configuration file exists in a text format, and the staff who is not able to program can also understand the parameter configuration file, which can be operated to set the screen parameters. In addition, modification of some parameter items in the screen parameters may cause the screen to not be displayed, if the user modifies those parameter items, the screen would not be displayed, and the screen parameters cannot be set any more. Therefore, the parameter items affecting the normal display of the screen are not displayed in the debugging module 6 to avoid misoperation in the process of setting the screen parameters.

In a preferred embodiment of the present invention, the above-mentioned screen parameter configuration system further comprises:

an extraction module 7, connected to the selection module 2, and configured to extract the corresponding screen parameter debugging information from the PowerShadow Master 15 according to the screen ID selected by the user;

a copy module 8, connected to the selection module 2 and the first storage module 1, configured to search the corresponding screen configuration information from the first storage module 1 according to the screen ID selected by the user and to copy the screen configuration information searched out by the user; and

a modifying module 9, connected to the copy module 8 and the extraction module 7, configured to obtain the copied screen configuration information and to modify the copied screen configuration information according to the screen parameter debugging information, and configured to configure the modified screen configuration information with a new screen ID to obtain new screen configuration information.

In a preferred embodiment of the present invention, the above-mentioned screen parameter configuration system further comprises:

an update module 11, connected to the first storage module 1 and the modifying module 9, and configured to update the new screen configuration information in the screen configuration file.

In a preferred embodiment of the present invention, the above-mentioned screen parameter configuration system further comprises:

a generation module 12, connected to the first storage module 1, and configured to generate an incremental upgrade package according to the new screen configuration information; and

an export module 13, connected to the generation module 12, and configured to export the incremental upgrade package operated by the user.

In a preferred embodiment of the present invention, the above-mentioned screen parameter configuration system further comprises:

an upgrade module 14, connected to the first storage module 1, configured to receive the incremental upgrade package, and configured to upgrade the operation system by using the incremental upgrade package, and configured to add the new screen configuration information to the screen configuration file.

In this embodiment, after the user obtains the desired screen parameters through the debugging module 6, the extraction module 7 extracts corresponding screen parameter debugging information (comprising the screen ID and the parameter items modified by the corresponding user) from the PowerShadow Master 15 according to the screen ID selected by the user. The copy module 8 copies the corresponding screen parameter information from the first storage module 1 according to the screen ID selected by the user, and the screen parameter information is modified according to the parameter items in the screen parameter debugging information. Then the modified screen parameter information is provided with a new screen ID to obtain new screen configuration information, finally, the new screen configuration information is updated into the new screen configuration file.

Furthermore, the incremental upgrade package is generated by the generation module 12 according to the new screen configuration information and is exported through the export module 13. The exported incremental upgrade package can upgrade the operation system of all the smart TV hosts on the production line to update the screen configuration files within the Smart TV hosts. Since the above incremental upgrade packages only contain one piece or more pieces of screen configuration information, its capacity is small, and upgrading the operation system by using the incremental upgrade package can be completed quickly.

Furthermore, in a preferred embodiment of the present invention, the above-mentioned screen parameter configuration system further comprises:

an edit module 10, connected to the upgrade module 11, and configured to edit the screen configuration information for the user.

If the user is able to edit the screen configuration information directly according to a corresponding user guide, the existing screen configuration information can be modified without using the debugging module 6 to obtain new screen configuration information, and the required screen configuration information can be directly edited by using the edit module 10.

The above descriptions are only the preferred embodiments of the invention, not thus limiting the embodiments and scope of the invention. Those skilled in the art should be able to realize that the schemes obtained from the content of specification and drawings of the invention are within the scope of the invention.

1: A screen parameter configuration system applied to an intelligent terminal, wherein the intelligent terminal is provided with a screen and an operation system, wherein the screen parameter configuration system is built based on the operation system, and wherein the screen parameter configuration system comprises:
a first storage module configured to store a screen configuration file in a default first format, wherein the screen configuration file comprises a plurality of screen configuration information, each of the plurality of screen configuration information comprises a screen ID and screen parameter information corresponding to the screen ID;
a selection module, connected to the first storage module, configured to provide a screen ID selection menu comprising a plurality of screen IDs for a user to select from, and configured to receive one of the plurality of screen IDs selected by the user;
a parse module, connected to the selection module and the first storage module, configured to read the screen ID selected by the user, configured to query the corresponding screen parameter information in the first storage module according to the screen ID, and configured to output a query result according to the corresponding screen parameter information; and
a conversion module, connected to the parse module, configured to convert the screen parameter information in the query result from the first format to a default second format, and configured to store the screen parameter information in the corresponding second format in a second storage module such that the screen parameter information is allowed to be read and utilized by an LCD driver in the operation system.

2: The screen parameter configuration system as claimed in claim 1, wherein the first format is a text format;
and the second format is a binary format.

3: The screen parameter configuration system as claimed in claim 1, wherein the operation system has a PowerShadow Master;
the screen parameter configuration system further comprises:
a debugging module, connected to the selection module, configured to have modifiable parameter items in the screen parameter information displayed on the screen according to the screen ID selected by the user, for the user to modify the corresponding parameter items, and configured to additionally save the parameter items modified by the user and the corresponding screen ID in the PowerShadow Master as screen parameter debugging information.

4: The screen parameter configuration system as claimed in claim 3, wherein the parse module comprises:
a first query unit, configured to query the screen parameter debugging information in the PowerShadow Master according to the screen ID selected by the user, and configured to output a first query result according to the parameter items when the corresponding screen parameter debugging information is obtained, and configured to output a second query result when the corresponding screen parameter debugging information is not obtained; and
a second query unit, connected to the first query unit, configured to query the first storage module according to the screen ID selected by the user so as to obtain corresponding screen parameter information upon receiving the second query result, and configured to output a third query result according to the screen parameter information, wherein the query result is the first query result or the third query result.

5: The screen parameter configuration system as claimed in claim 3, further comprising:
An extraction module, connected to the selection module, and configured to extract the corresponding screen parameter debugging information from the PowerShadow Master according to the screen ID selected by the user;
a copy module, connected to the selection module and the first storage module, configured to search the corresponding screen configuration information from the first storage module according to the screen ID selected by the user and to copy the screen configuration information searched out by the user; and
a modifying module, connected to the copy module and the extraction module, configured to obtain the copied screen configuration information and to modify the copied screen configuration information according to the screen parameter debugging information, and configured to configure the modified screen configuration information with a new screen ID to obtain new screen configuration information.

6: The screen parameter configuration system as claimed in claim 1, further comprising:
an edit module, configured to edit the screen configuration information for the user.

7: The screen parameter configuration system as claimed in claim 5, further comprising:
an update module, connected to the first storage module and the modifying module or the edit module, and configured to update the new screen configuration information in the screen configuration file.

8: The screen parameter configuration system as claimed in claim 6, further comprising:
an update module, connected to the first storage module and the modifying module or the edit module, and configured to update the new screen configuration information in the screen configuration file.

9: The screen parameter configuration system as claimed in claim 7, further comprising:
a generation module, connected to the first storage module, and configured to generate an incremental upgrade package according to the new screen configuration information; and
an export module connected to the generation module, and configured to export the incremental upgrade package operated by the user.

10: The screen parameter configuration system as claimed in claim 8,
further comprising:
a generation module, connected to the first storage module, and configured to generate an incremental upgrade package according to the new screen configuration information; and
an export module, connected to the generation module, and configured to export the incremental upgrade package operated by the user.

11: The screen parameter configuration system as claimed in claim 9, further comprising:
an upgrade module, configured to receive the incremental upgrade package, and configured to upgrade the operation system by using the incremental upgrade package.

12: The screen parameter configuration system as claimed in claim 10, further comprising:
an upgrade module, configured to receive the incremental upgrade package, and configured to upgrade the operation system by using the incremental upgrade package.
